(19) United States
(12) Patent Application Publication
(10) Pub. No.: US 2002/0189770 A1
(43) Pub. Date: Dec. 19, 2002

(54) Decorative window shutter

(76) Inventor: Michelle C. Van Hee, Chetwynd (CA)

Correspondence Address: ANTONY C. EDWARDS, SUITE 800, 1708 DOLPHIN AVENUE, KELOWNA, BC, V1Y 9S4, CA

(21) Appl. No.: 10/168,859

(22) PCT Filed: Dec. 20, 2000
(86) PCT No.: PCT/CA00/01565

(30) Foreign Application Priority Data
Dec. 31, 1999 (CA) 2,291,291

(51) Int. Cl. E06B 9/24

(52) U.S. Cl. 160/210; 160/371

(57) ABSTRACT

At least one rigid shutter frame is pivotally mountable to a window frame on the inside of a dwelling. The shutter may be pivoted from a closed position covering the window to an open position which may be generally parallel to a portion of the wall of a dwelling adjacent to the window frame. The shutter has at least one light transmitting aperture formed therethrough, the edges of which are not parallel to the edges of the shutter frame but are decoratively formed in outline within the light transmitting aperture of the frame. The shutter frame, in co-operation with its light transmitting aperture formed therethrough, may be a bi-fold shutter. The shutter frame may be decorated, separately or in combination, with a backdrop of light diffusing fabric sheer curtains sandwiching light inhibiting curtains between the sheer curtains and the frame. The sandwiched curtains may be centrally gathered or may be colorful murals made from translucent fabric panels or may be slats.

### FIELD OF THE INVENTION

This invention relates to a decorative window shutter which is hinged on the inside surface of a window frame or other opening, for ready opening and closing across the window or opening and in particular a decorative window shutter which has a light transmitting aperture of decorative outline formed therethrough which may be covered by a decorative translucent background such as curtains, slats or the like.

### BACKGROUND OF THE INVENTION

Window shutters are well known as a suitable means for increasing privacy within a dwelling as well as reducing the affects of exterior temperatures upon the interior temperature of a dwelling. Heretofore, functionality of the shutter has generally taken precedence over aesthetics. This has generally resulted in the shutter being placed on the exterior of the dwelling and the shutter being constructed of a contiguous, planar and generally opaque window covering surface which is movable to a closed position over a window.

Such shutters suffer from several deficiencies, such as the inconvenience to the user of having to externally adjust the shutter, the inability to see through the window, and the attenuation of light entering the dwelling when the shutter is in its fully closed position. There is the further inability to easily adjust the shutter so as to selectively admit varying levels of light into the dwelling while still reducing the effects of external temperatures on the inside temperature of the dwelling. With presently available shutters of which applicant is aware, the user cannot conveniently and selectively decorate and adjust that portion of the shutter, viewed in its closed position, from inside the dwelling so as to compliment the furnishings of a room within a dwelling, adjust light transmission levels and degree of insulation. Further, the shutter when closed and viewed from the exterior of a dwelling provides privacy levels which are adjustable from inside the dwelling.

In the prior art within this field, the applicant is aware of U.S. Pat. Nos. 4,699,195 and 5,063,985, both of which teach a blind, either fabric or slatted, which is an internal covering for an arched window. Such blinds, it is acknowledged, may be manufactured from material having decorative patterns, or the stationary components of such blinds may have removable decorative fixtures placed thereon.

### SUMMARY OF THE INVENTION

In the present invention, at least one rigid shutter frame is pivotally mountable to a window frame on the inside of a dwelling. The shutter may be pivoted from a closed position covering the window to an open position which may be generally parallel to a portion of the wall of a dwelling adjacent to the window frame. The shutter has at least one light transmitting aperture formed therethrough, the edges of which are not parallel to the edges of the shutter frame but are decoratively formed in outline within the light transmitting aperture of the frame. The shutter frame, in co-operation with its light transmitting aperture formed therethrough, may be a bi-fold shutter. The shutter frame may be decorated, separately or in combination, with a backdrop of light diffusing fabric sheer curtains sandwiching light inhibiting curtains between the sheer curtains and the frame. The sandwiched curtains may be centrally gathered or may be colorful murals made from translucent fabric panels or may be slats.

In summary, the present invention relates to a decorative window shutter which can be pivotally mounted to the inside surface of a window frame or other opening such as a cupboard or patio door.

The shutter has a rigid frame having an outer and an inner perimeter edge and may be pivoted from a closed position lying generally parallel to and across the window frame or other opening, to an open position where the shutter is pivoted outwardly from the window to lie adjacent to and generally parallel to a portion of a wall immediately adjacent to the window frame.

The shutter may be a pair of shutters, each of which is mounted to opposite vertical sides of the window frame and in a closed position extend across the window, for example to a substantially medial point laterally across the window. Depending upon the lateral width of the window, two or more shutters may be bi-fold shutters hingedly interconnected, each bi-fold shutter mounted to opposite vertical sides of the window frame.

The outer and an inner perimeter edge of the shutter frame define between them a front surface which is exposed into a room when said shutter is in the closed position and a back surface opposite to the front surface. The inner perimeter edge of the shutter frame defines a light transmitting aperture through the shutter frame. The perimeter edge of the aperture are, at least in part, not parallel to the outer perimeter edge of the shutter frame so to thereby provide a decorative shape or outline to the aperture. Alternatively, a portion of the perimeter edge of the aperture may define an object in outline which protrudes from the inner edge into the light transmitting aperture. The decorative outline, including one which is shaped as a recognizable object, is backlit by light passing through the aperture from the back of the shutter frame.

Light permeable curtains or sheers may be mounted to the back surface of the shutter frame so that light passing through the curtains will enhance the outline of the decoratively shaped aperture or object. The light permeable curtains or sheers may alternatively, be in the form of either a multicolored fabric mural or panels of translucent colored glass or slats.

A gathered curtain, separately or in combination with a light permeable fabric sheer material, may be positioned on the back surface of the shutter frame between the back surface of the shutter frame and the light permeable curtains, so as to be exposed through the decoratively shaped aperture. The gathered curtain may be sandwiched between the sheers and the back surface of the shutter frame. The gathered curtain layer may have its unattached edges gathered medially along a portion of its length by a ribbon or the like.

### BRIEF DESCRIPTION OF THE DRAWINGS

FIG. 1 is a front perspective view of a partially open bi-fold shutter according to the present invention flush mounted to the inside of a window frame.

FIG. 1a is a perspective view of a bi-fold shutter, partially opened, mounted to an auxiliary frame mounted to the inside of a window.

FIG. 1b is an enlarged sectional view taken on line 1b-1b of FIG. 1a.

FIG. 2 is a portion of the shutter of FIG. 1 in a position approaching a fully open position.

FIG. 3 is an elevational view of a shutter where the decoratively shaped light transmitting aperture is closed by an array of pivotally mounted slats.

FIG. 4 is a front elevational view of a shutter where the decoratively shaped light transmitting aperture is backed by a curtain gathered medially along its horizontal edges and backed by light permeable sheer.

FIG. 5 is an elevational view of a shutter where the decoratively shaped light transmitting aperture is an ellipse backed by curtains which are openable along a vertical medial line.

FIG. 6 is an elevational view of a shutter where the decoratively shaped light transmitting aperture is a parallelogram and curtains are attached to the opposite parallel sides of the aperture.

FIG. 7 is an elevational view of a shutter having upper and lower light transmitting apertures each containing a bi-fold shutter, wherein each bi-fold shutter has vertically aligned light transmitting apertures backed by selectively positionable curtains which are backed by fabric sheers.

FIG. 8 is an elevational view of a shutter wherein one end of the decoratively shaped light transmitting aperture is arched and the aperture is backed by a mural.

FIG. 9 is an elevational view of a shutter formed in upper and lower sections, where the upper section is a pair of complementary bi-folds, each having a decorative light transmitting aperture, and the lower section is fixed and contains a decorative opening backed by a curtain and sheer.

FIG. 10 is an elevational view of a shutter where the decoratively shaped light transmitting aperture is generally rectangular in shape and where a portion of an inner edge is formed so as to define a decorative object which protrudes from the inner edge into the light transmitting aperture.

FIG. 11 is an elevational view of a bi-fold shutter containing light transmitting apertures and where the upper edge of the shutter is formed as an arch.

FIG. 12 is an elevational view of a bi-fold shutter containing light transmitting apertures and where the shutter is circular.

FIG. 13 is an elevational view of a shutter where the light transmitting aperture is in the outlined shape of a decorative object.

### DETAILED DESCRIPTION OF EMBODIMENTS OF THE INVENTION

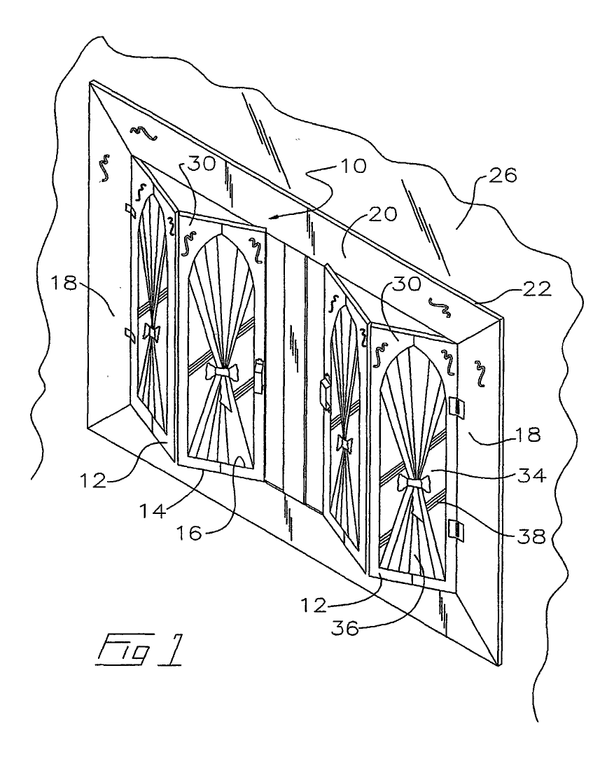

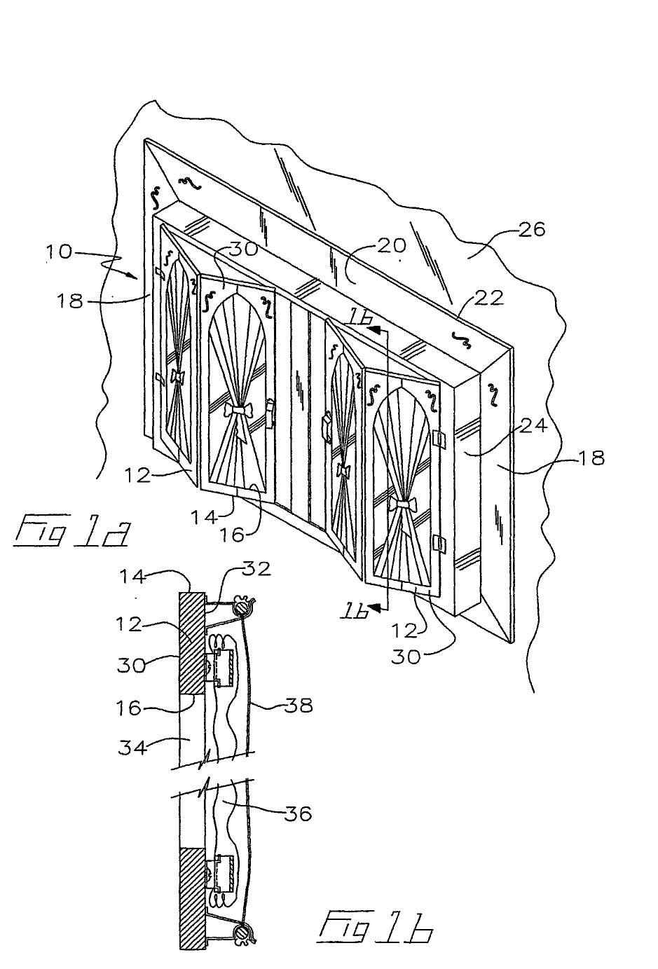

With reference to the accompanying drawing figures, wherein similar reference characters denote corresponding parts in each view, the decorative window shutter 10, has a rigid frame 12 having outer and inner perimeter edges 14 and 16 respectively. Shutter 10 is, at a portion of its outer edge 14, hingedly mounted to the vertical sides 18 of the inside surface 20 of a window frame 22, or similar opening. Alternatively, as may be seen in FIG. 1a, shutter 10 may be hingedly mounted to an auxiliary frame 24, which is mounted to surface 20 of window frame 22, to space shutter 10 inwardly toward a room of a dwelling from surface 20 of window frame 22.

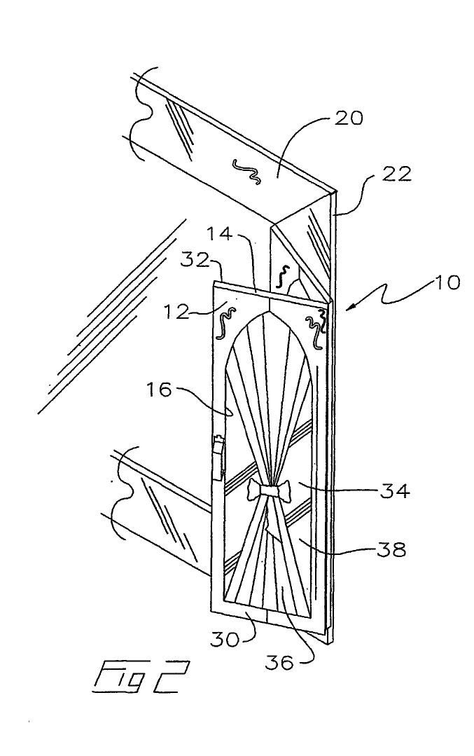

Shutter 10 may, depending upon the lateral width of the window, be a pair of shutters, or a pair of bi-fold shutters as illustrated in FIGS. 1 and 1a. Each pair of bi-fold shutters is hingedly mounted to one another and mounted to opposite vertical sides 18 of window frame 22. In a closed position shutter 10 extends across the window for example to a substantially medial point of the window, and in an open position, as generally illustrated in FIG. 2, is drawn away from the window to lie generally parallel to a portion of a wall 26 immediately adjacent window frame 22.

Shutter 10 has a front surface 30 which is exposed into a room when the shutter is closed and a back surface 32 opposite to the front surface. The inner perimeter edge 16 defines a decoratively shaped light transmitting aperture 34 through shutter 10. Light permeable fabric curtains 36 and/or sheers 38 may be mounted separately or in combination to the back surface 32 of shutter 10. Aperture 34 allows visual exposure of the curtains 36 from within a room enhancing the esthetics of shutter 10. Curtains 36 may be partially gathered about a horizontal or vertical medial point to enhance the decorative and pleasing visual effect Fabric sheers 38 are translucent so as to permit diffused exterior day light into a room while still maintaining privacy.

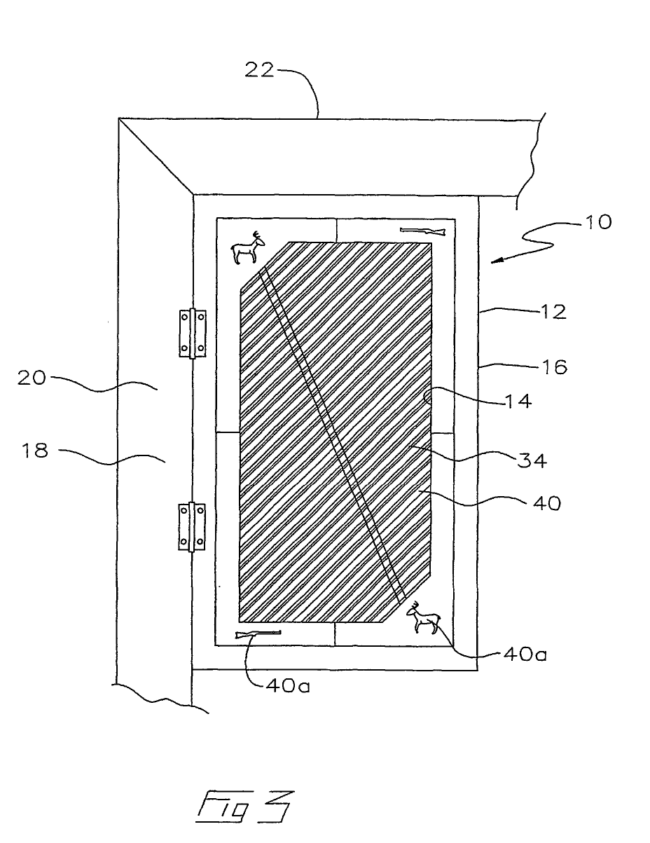

As seen in FIG. 3, light transmitting aperture 34 may be generally rectangular in shape. A slatted blind 40 may be mounted to back surface 32 of shutter 10. Slatted blind 40 may be of the kind which may be biased into open or closed positions by pivoting of the slats. Blind 40 is mounted behind shutter 10 and may be backed by a fabric sheer 38. Shutter 10 may contain design elements, for example engravings, 40a, on front surface 30, which provide additional visual ornamental enhancement to the shutter.

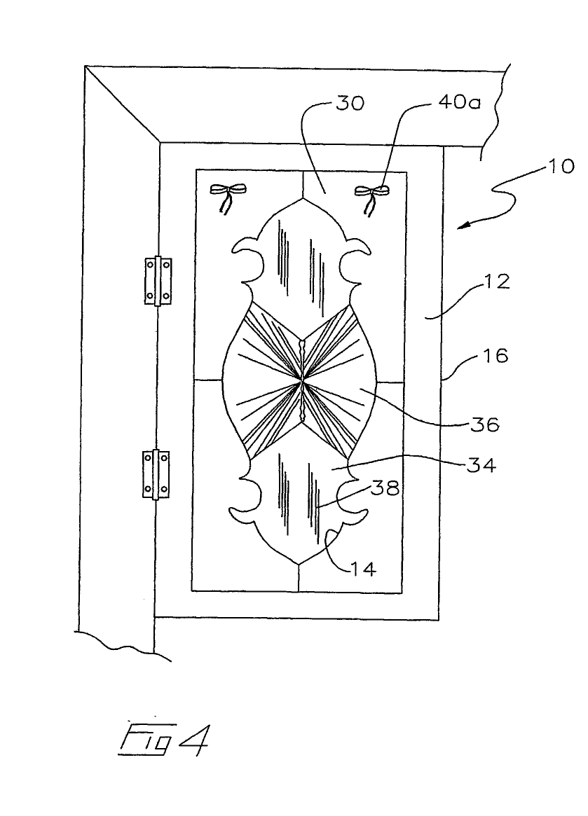

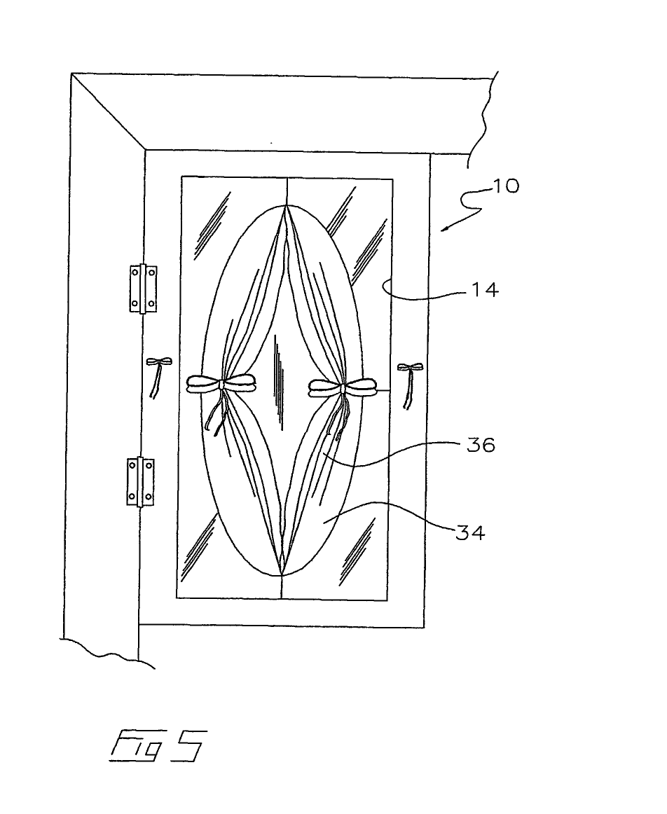

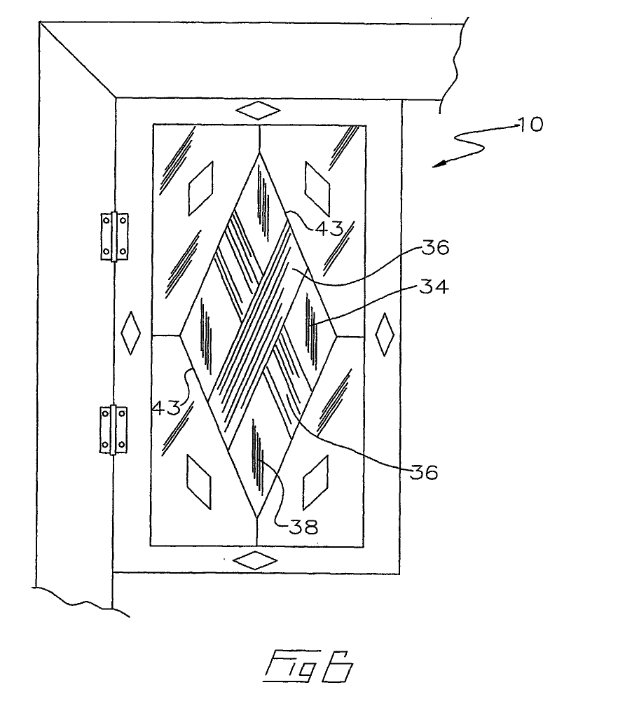

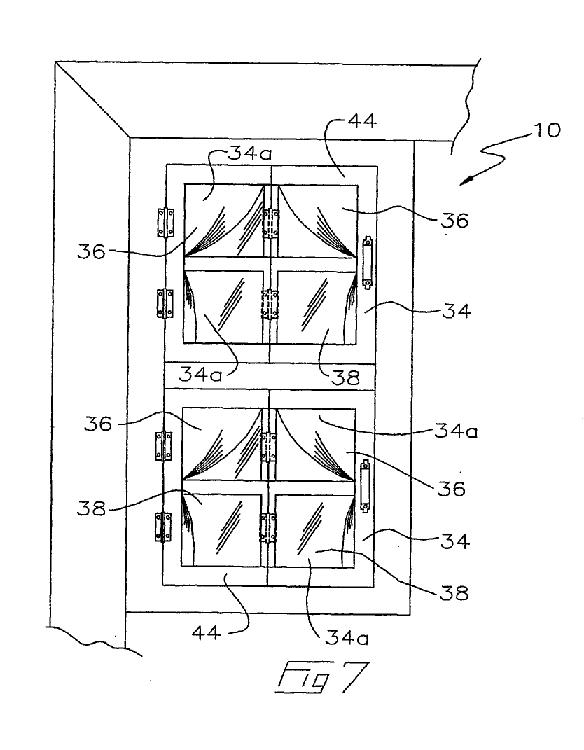

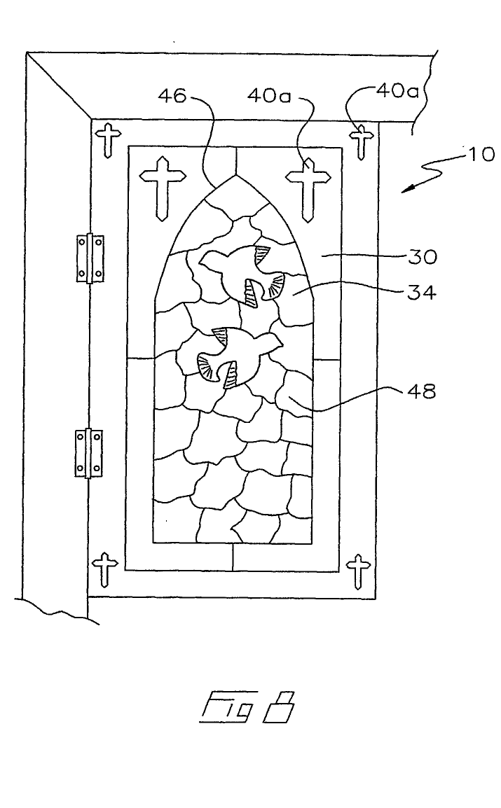

In FIG. 4, shutter 10 is depicted where inner perimeter edge 14 of frame 20 is formed so as to create a light transmitting aperture 34 having a decoratively sculptured shape. Aperture 34 is backed by a curtain 36 which is gathered medially along its horizontal edges and backed by light permeable fabric sheer 38. Design elements 40a, on front surface 30, provide visual enhancement to the shutter.

In FIG. 5 shutter 10 has inner perimeter edge 14 creating an aperture 34 in the shape of an ellipse. Aperture 34 is backed by curtains 36 which are openable along a vertical medial line and backed by a fabric sheer 38. Ribbons 41 or the like may by utilized to keep curtain 36 in an open position.

In FIG. 6 shutter 10 has light transmitting aperture 34 in the shape of a parallelogram backed by curtains 36 which extend between opposite parallel sides 43 of aperture 34 to cross over at a medial point within aperture 34. Additional design elements 40a, in proportion to surface 30, may be inscribed or attached to shutter 10 forming a decorative motif therearound. Curtains 36 are backed by a fabric sheer 38.

The shutter 10, of FIG. 7, has upper and lower light transmitting apertures 34 which are fitted with small bi-fold shutters 44. Shutters 44 each have vertically aligned light transmitting apertures 34a backed by selectively positionable curtains 36. Curtains 36, in each of the small bi-fold light transmitting apertures 34a are backed by a fabric sheer 38.

In FIG. 8, shutter 10 has a generally rectangular light transmitting aperture 34 with the longitudinal edges rounded or arch shaped at one end as at 46. The aperture 34 is backed by a colorful design or mural 48 made from pieces of fabric, glass or the like. Additional design elements 40a corresponding to the theme of the mural decoratively enhance the front surface 30 of shutter 10.

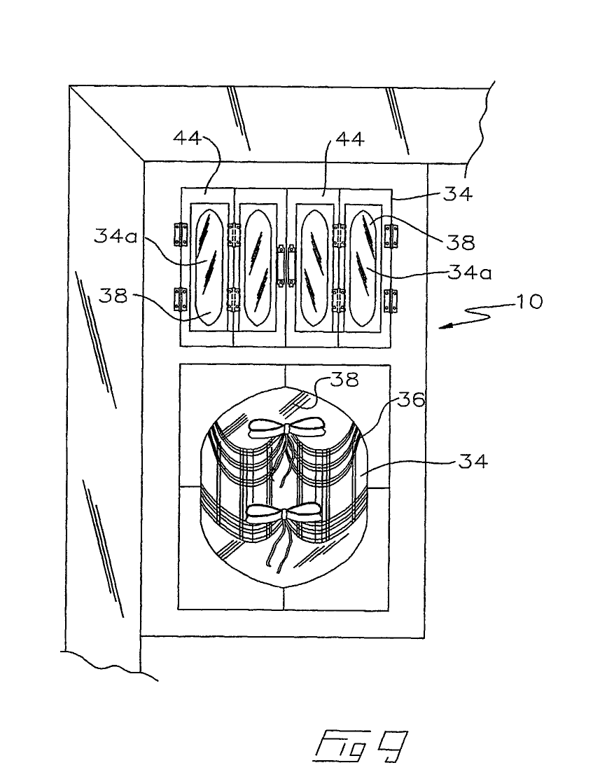

In FIG. 9 an alternative form of shutter 10 is shown, having upper and lower light transmitting apertures 34. Upper aperture 34 is generally rectangular and contains side by side bi-fold shutters 44 where each bi-fold section contains a light transmitting aperture 34a with rounded ends. Each of these apertures 34a is backed by a fabric sheer 38. The lower section of shutter 10 is non-openable but contains a relatively large light transmitting aperture 34 with complementary rounded ends and backed by a fabric curtain 36 and sheer 38.

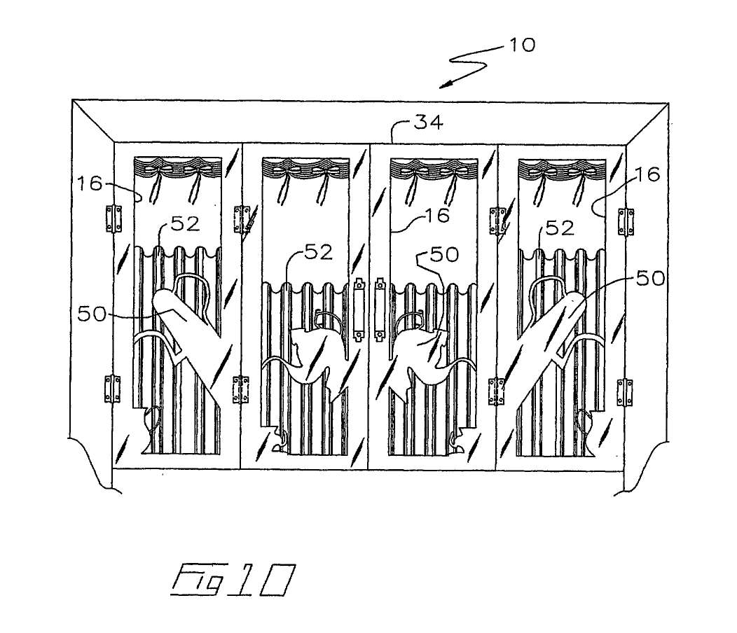

FIG. 10 illustrates a shutter 10 which is a bi-fold shutter, where the decoratively shaped light transmitting aperture 34 is generally rectangular in shape. A portion of an inner edge 16 of aperture 34 is formed so as to define a decorative object 50 which protrudes from the inner edge 16 into the light transmitting aperture 34 so as to be in relief as viewed from the inside of the dwelling. The example of coffee and tea pots, and receiving cups, are illustrated. These may be thematically cued to the room, such as a kitchen theme. Aperture 34 is backed by fabric cottage curtains 48 or the like.

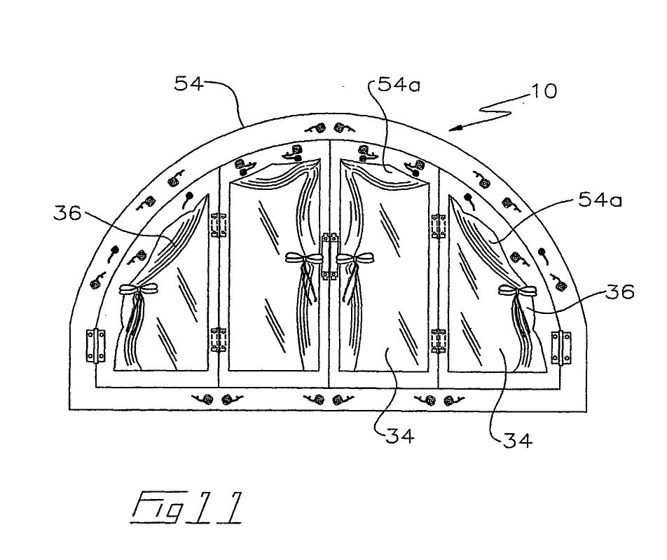

The bi-fold shutter 10 of FIG. 11 has an upper edge 54 formed as an arch. The light transmitting apertures 34 within shutters 10 have a complimentary curved surface 50a, and are backed by fabric curtains 36 which can be drawn to one side to enhance exterior light transmission through a fabric sheer 38 and into a room of a dwelling.

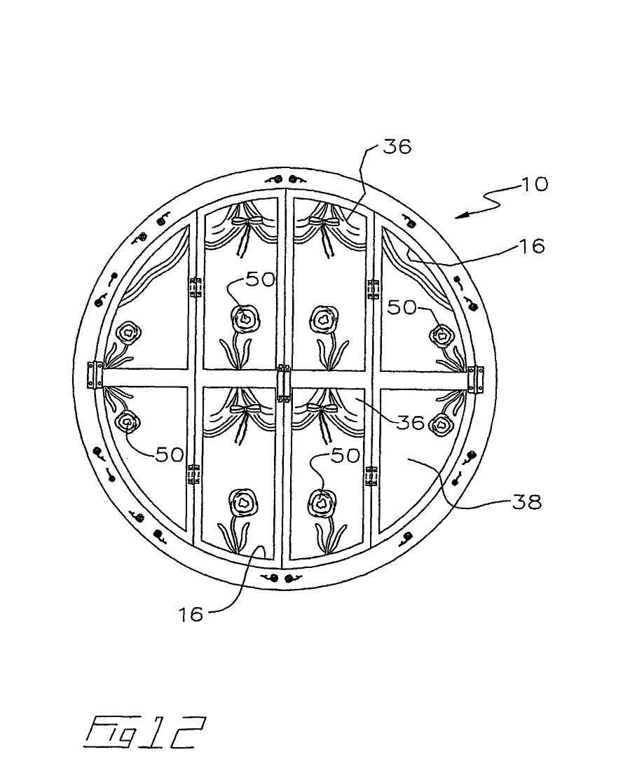

FIG. 12 illustrates a bi-fold shutter 10 formed in a circular configuration where the upper and lower edges of the shutter are formed as an arch. A portion of an inner edge 16 is formed so as to define objects 50, in this case flowers, which protrude from the inner edge 16 into the light transmitting apertures 34 formed in the shutter 10. Light transmitting apertures 34 are, again, backed by fabric curtains 36 and fabric sheer 38.

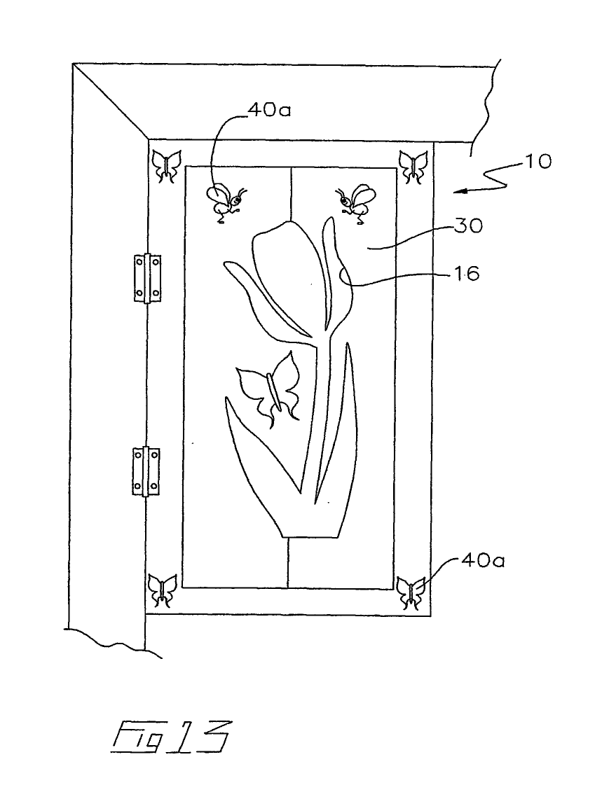

FIG. 13 illustrates a rectangularly shaped shutter 10 where the inner edge 16 of light transmitting aperture 34 conforms to the decorative outline of an object. The front face 30 of shutter 10 may have complimentary design elements 40a to enhance the shutter.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A decorative window shutter comprising
a rigid first shutter frame pivotally mountable to a window frame so that, once pivotally mounted to said window frame, in a closed position said first shutter frame is pivoted so as to lie across a window within said window frame, and in an open position said first shutter frame is pivoted away from said window so as not to substantially obscure said window,
wherein said first shutter frame has a front surface which is exposed into a room when said first shutter frame is mounted to said window frame and in said closed position, and wherein said first shutter frame has a back surface opposite said front surface,
and wherein said first shutter frame has an outer perimeter edge and an inner perimeter edge defining therebetween front and back lands corresponding to said front and back surfaces respectively, said inner perimeter edge defining an aperture within said first shutter frame, said aperture extending from said front surface to said back surface, wherein in front elevation at least a portion of said inner perimeter edge is not parallel to a corresponding portion of said outer perimeter edge so as to provide a decorative foreground for said shutter when viewed in front elevation,
a generally planar, light permeable background mounted to said back surface across said aperture in substantially co-planar relation to said front surface so as to provide a decorative backdrop cooperating with said decorative foreground so that light passing through said background backlights a decorative shape defined by said inner perimeter edge.

2. The shutter of claim 1 wherein said background is at least one textile layer.

3. The shutter of claim 2 wherein said at least one textile layer includes a gathered curtain layer, said gathered curtain layer at least partially gathered within a light transmitting portion of said gathered curtain layer corresponding to said aperture in said first shutter frame.

4. The shutter of claim 3 wherein said at least one textile layer further includes a sheer curtain layer mounted behind said gathered curtain layer so as to sandwich said gathered curtain layer between said sheer curtain layer and said back surface of said first shutter frame.

5. The shutter of claim 3 wherein said inner perimeter edge is shaped so as to define at least one decorative object, said objects positioned across light transmitted through said light transmitting portion.

6. The shutter of claim 1 wherein said inner perimeter edge is shaped as at least one decorative object.

7. The shutter of claims 5 or 6 wherein said at least one decorative object is a pot having a spout.

8. The shutter of claim 3 wherein said gathered curtain layer is gathered generally medially along its length.

9. The shutter of claims 3 or 8 wherein said gathered curtain layer is gathered symmetrically relative to a longitudinal axis of said first shutter frame.

10. The shutter of claim 1 wherein said background is an array of slats.

11. The shutter of claim 10 wherein slats in land array of slats are pivotally mounted to said shutter for simultaneous pivoting relative to said first shutter frame so as to control quantity of light transmitted through said aperture.

12. The shutter of claim 11 wherein said inner perimeter edge is shaped as at least one decorative object.

13. The shutter of claim 12 wherein said inner perimeter edge is shaped as at least one decorative object.

14. The shutter of claim 1 further comprising a rigid second shutter frame pivotally mountable to said first shutter frame on a second edge of said outer perimeter edge opposite to a first edge of said outer perimeter edge pivotally mountable to said window frame,
said second shutter frame pivotally mountable to said first shutter frame so that, once pivotally mounted to said first shutter frame, in a closed position said second shutter frame is pivoted so as to lie across said window within said window frame, and in an open position said second shutter frame is pivoted away from said window so as not to substantially obscure said window and so as to overlay said first shutter frame,
wherein said second shutter frame has a front surface which is exposed into a room when said first shutter frame is mounted to said window frame and said second shutter frame is mounted to said first shutter frame and wherein said second shutter frame has a back surface opposite its front surface,
and wherein said second shutter frame has an outer perimeter edge and an inner perimeter edge defining therebetween front and back lands corresponding to said front and back surfaces respectively, said inner perimeter edge defining an aperture within said second shutter frame, said aperture extending from said front surface to said back surface, wherein at least a portion of said inner perimeter edge of said second shutter frame is not parallel to a corresponding portion of said outer perimeter edge of said second shutter frame when said shutter is viewed in front elevation so as to provide a decorative foreground for said shutter when viewed in front elevation,
a generally planar light permeable background mounted to said back surface of said second shutter frame across said aperture in substantially co-planar relation to said front surface of said second shutter frame so as to provide a decorative backdrop cooperating with said decorative foreground of said second shutter frame.

15. The shutter of claim 14 wherein, in said open position, said front surface of said second shutter frame is exposed into the room and said first shutter frame is hidden behind said second shutter frame, sandwiched between said second shutter frame and a wall adjacent said window frame.

16. The shutter of claim 14 wherein said first and second shutter frames are bi-fold shutter frames.

17. The shutter of claim 1 wherein said first shutter frame is generally rectangular and said aperture is elongate.

18. The shutter of claim 17 wherein said aperture is formed as an arch at least one end of said aperture.

19. The shutter of claim 17 wherein said aperture is symmetric about a longitudinal axis of said aperture.

20. The shutter of claim 19 wherein said aperture is symmetric about a lateral axis of said aperture.

21. The shutter of claim 20 wherein said longitudinal and lateral axes are perpendicular and each bisect said first shutter frame.

22. The shutter of claim 1 wherein said background is a multi-coloured mural.

23. The shutter of claim 22 wherein said mural is made of panels of translucent glass.
